(19) United States
(12) Patent Application Publication
(10) Pub. No.: US 2012/0267423 A1
(43) Pub. Date: Oct. 25, 2012

(54) Methods and Apparatus for Thin Die Processing

(75) Inventors: Kuei-Wei Huang, Hsin-Chu (TW); Wei-Hung Lin, Xinfeng Township (TW); Meng-Tse Chen, Changzhi Township (TW); Chun-Cheng Lin, New Taipei City (TW); Yu-Peng Tsai, Taipei City (TW); Bor-Ping Jang, Chu-Bei (TW); Chung-Shi Liu, Hsin-Chu (TW)

(73) Assignee: Taiwan Semiconductor Manufacturing Company, Ltd., Hsin-Chu (TW)

(21) Appl. No.: 13/089,977

(22) Filed: Apr. 19, 2011

(51) Int. Cl. B23K 1/20; B25J 15/06

(52) U.S. Cl. 228/223; 294/183; 294/188

(57) ABSTRACT

A vacuum tip and methods for processing thin integrated circuit dies. A vacuum tip for attaching to an integrated circuit die is disclosed comprising a vacuum port configured to connect to a vacuum supply on an upper surface and having a bottom surface; and at least one vacuum hole extending through the vacuum tip and exposed at the bottom surface of the vacuum tip; wherein the vacuum tip is configured to physically contact a surface of an integrated circuit die. Methods for processing integrated circuit dies are disclosed.

### BACKGROUND

A common requirement for an advanced electronic circuit and particularly for circuits manufactured as integrated circuits (“ICs”) in semiconductor processes is the use of equipment to transport integrated circuit dies for various operations. For example, for a die having solder bumps or solder ball connectors placed on the electrical terminals configured to couple the circuitry within the integrated circuit die to external connections, a flux operation is performed. This operation requires that the die be picked up and placed at the top of a solder flux, which is provided as a liquid, and then immersing a portion of the integrated circuit into the flux for coating the solder balls or solder bumps.

Vacuum “pick and place” tools typically use a vacuum to attach the die to the tip of the tool. A vacuum port is provided and vacuum paths may couple several holes in the tool to the vacuum source. In known prior vacuum tip tools, a rubber or other compliant edge is provided. The surface of the integrated circuit die contacts the pick and place tool only along this rubber edge. The remaining portion of the integrated circuit die surface is not supported but is exposed to the vacuum. Once the vacuum tip makes contact to the die and applies a vacuum to attach the die to the tool, it can securely lift and move, or “pick and place” the die. The die may be moved to other tools and various operations may be performed, the solder bump flux operation is only one possible operation. Once the die is placed in another processing tool or storage area, the vacuum is released and the tip is moved away from the die.

Recently, as die sizes shrink and semiconductor processes advance, the thickness of wafers and the resulting completed integrated circuit dies is also falling. As a result, dies have a much reduced thickness compared to prior integrated circuit dies. As a consequence the use of known pick and place vacuum tools can result in a warp, or horizontal deformation, of the die when it is attached to the vacuum tool. This warp may result in non-uniform processing. In the example solder bump fluxing operation described above, yield problems have been observed because the solder bumps in a central portion of the die may be displaced towards the vacuum hole or holes by the die deformation or warping. The solder bumps in the deformed area of the die may receive less flux, or even no flux, in the solder fluxing operation and yield problems may result. When the dies are later mounted on a substrate, a “cold joint” failure may occur at one or more of the solder bumps that do not receive the appropriate amount of flux. Other process steps that require positioning of the die may also experience yield problems due to warpage in a vacuum tool, such as die stacking operations. Die crack and joint failures can occur in assembled devices where dies are stacked, or otherwise mounted.

A continuing need thus exists for vacuum pick and place tools and methods that overcome the disadvantages of the prior art approaches.

### BRIEF DESCRIPTION OF THE FIGURES

For a more complete understanding of the present invention, and the advantages thereof, reference is now made to the following descriptions taken in conjunction with the accompanying drawings, in which:

FIG. 1 depicts a cross section of an embodiment vacuum pick and place tip positioned above an integrated circuit die;

FIG. 2 depicts a cross section of the embodiment vacuum pick and place tip in contact with the integrated circuit die;

FIG. 3 depicts a plan view of the bottom surface of an embodiment vacuum pick and place tip illustrating one embodiment of vacuum ports in the tip; and

FIG. 4 depicts a plan view of the bottom surface of an embodiment pick and place tool illustrating an alternative arrangement of vacuum ports in the tip.

The drawings, schematics and diagrams are illustrative and not intended to be limiting, but are examples of embodiments of the invention, are simplified for explanatory purposes, and are not drawn to scale.

### DETAILED DESCRIPTION

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Embodiments of the present application which are now described in detail provide novel die pick and place tools and methods to provide a die pick and place tool without deforming dies, particularly dies with thicknesses of less than 10 mils. These tools may be used with processes where dies are picked and placed using vacuum tools, for example for transporting the dies to a station for applying flux to solder bumps on a bottom surface of a die, by moving the die to a flux bath and moving the die partially into the bath, so that the solder bumps are uniformly exposed to the liquid flux.

In an embodiment, a vacuum pick and place tool is provided that is arranged to make physical contact with the majority of the surface area of an integrated circuit die. The vacuum tip may be formed of a material such as, in one non limiting example, bakelite, a moldable plastic, which is a thermosetting phenol formaldehyde resin. It is an electrically non conductive, heat resistant material. Other resins, plastics, ceramics, glass, and metals may be used as alternatives and the embodiments are not limited to bakelite, which is but one embodiment. Composite materials and alloys may be used. Liners and coatings may be added to the vacuum tip.

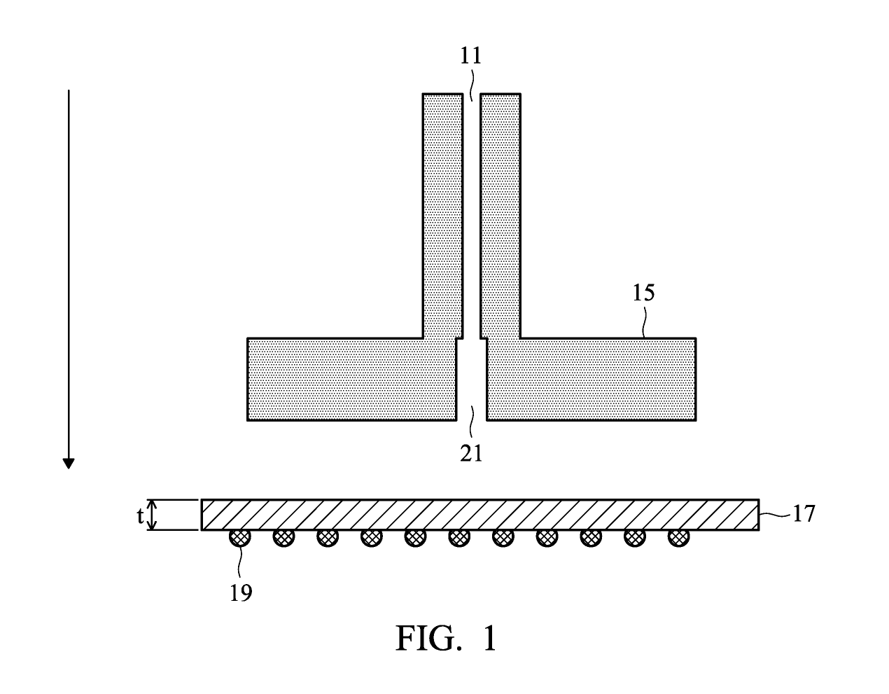

In FIG. 1, a cross sectional view of one embodiment of a pick and place vacuum tip 15 positioned above an example IC die 17 is shown. Vacuum tip 15 is depicted with a vacuum port 11 for receiving a vacuum supply (not shown). The tip 15 has a cross sectional area similar to that of the die, about 10 microns on a side, but the area of the tip may vary with the die type and the semiconductor processing technology being used to manufacture the die. The example die is shown with a thickness ‘t’ of about 4 mils. However the die thickness may vary and may range from 1 to 10 mils, for example, and even thicker dies may also be used with the embodiments, although the greatest improvements are achieved for dies of less than 10 mils thickness. A vacuum hole 21 is shown connected to the vacuum port 11. In an alternative embodiment, additional vacuum holes are provided and connected to the vacuum port.

The vacuum tip 15 is arranged specifically to be placed in physical contact with the majority of the cross sectional area of the upper surface of the die 17. This is an important advantage of the vacuum tip embodiments, and contrasts sharply to the edge contacting vacuum tips known previously. In various alternative embodiments, the vacuum tip may contact from 80% or more of the surface area of the die.

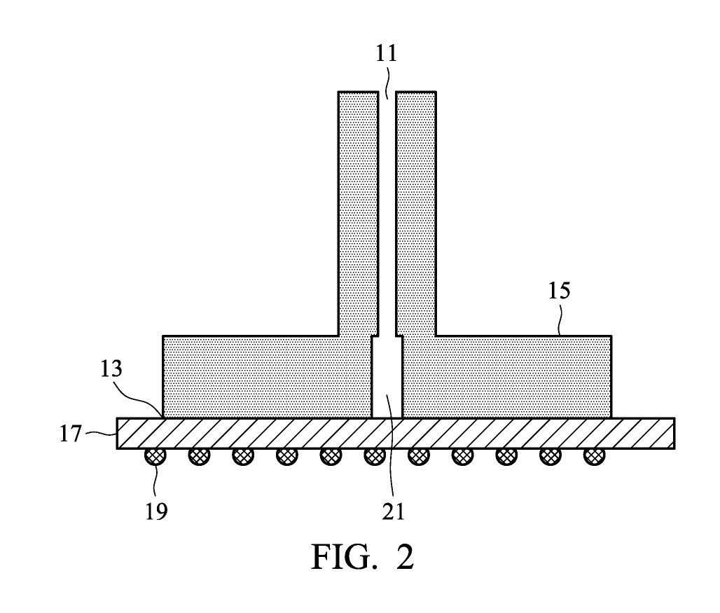

In FIG. 2, use of the tip in picking up a die is illustrated. As shown in FIG. 2, the vacuum tip 15 contacts the die 17 at interface 13. After the contact is made, vacuum is applied to secure the die 17 to the tip. Vacuum is supplied from vacuum port 11 to the vacuum hole 21 and thus to the surface of the die 17. The vacuum is of sufficient strength to hold the die 17 securely to the tip 15. When the die is to be released from the tip, the vacuum is removed and the tip 15 is able to move away from the die without further movement of the die. When the vacuum is applied to the upper surface of the die 17 to attach the die to the vacuum tip 15, the die 17 is supported across most of its surface area, and no deformation or warp occurs, even when the vacuum tip is used with very thin dies. As the semiconductor processes advance, dies are becoming increasingly thinner and so the physical support of the die at the upper surface prevents deformation or warp of the die when the vacuum is applied. As a result the entire die remains in horizontal alignment and processes applied to the bottom surface, such as applying flux to solder bumps 19, have a uniform result across the die. Thus the yield problems observed with the use of vacuum tips known in the art are reduced or eliminated. The vacuum tips of the embodiments may be used for any process where pick and place operations are performed, such as packaging, die stacking, solder bump and solder flux, and others.

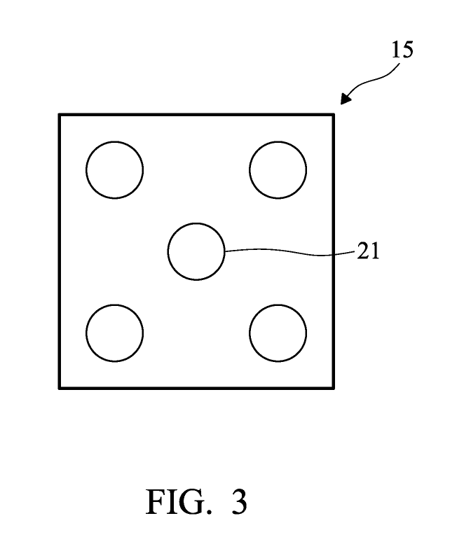

FIG. 3 depicts one embodiment of the vacuum tip 15 in a plan view illustrating the bottom surface. The plan view in FIG. 3 depicts a pattern of vacuum holes 21 for forming the vacuum tip. While five vacuum holes are shown in FIG. 3, more or less vacuum holes may be used. The material between the vacuum holes forms a planar bottom surface that will contact the upper surface of the semiconductor die and provide the needed mechanical support to the die while the vacuum is applied. The material may contact at least 80% of the surface area of the die. Thus, when the vacuum is applied to the tip, the die is supported, and the die will not deform or warp. As a result, processes applied to the die while it is attached to the tip will have uniform results.

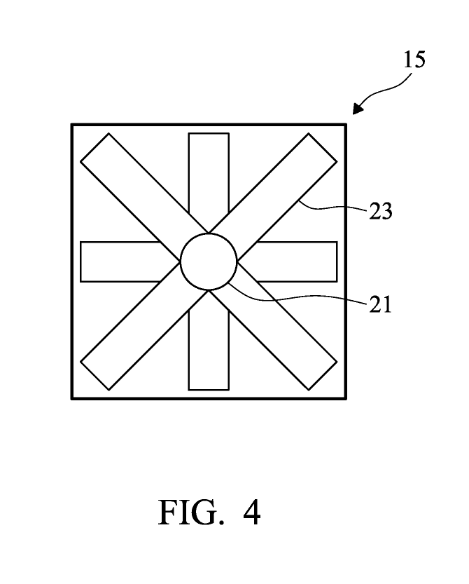

FIG. 4 depicts in a plan view the bottom surface of another embodiment vacuum tip 15. In FIG. 4, the tip has a pattern of vacuum paths 23 extending radially outward from the central vacuum hole 21. Again, the material that remains around the vacuum paths will contact and mechanically support 80% of more of the top surface of the integrated circuit die during a vacuum pick and place operation. This mechanical support prevents deformation of the die when a vacuum is applied, and again the processes applied to the die during a vacuum pick and place will achieve uniform results.

While in one example embodiment the vacuum tip is made of bakelite, a plastic resin, in alternative embodiments other materials that are affordable and sufficiently durable, and providing the required mechanical support, may be used. Ceramics, plastics, resins, glass, and other materials may be used to form the vacuum tip. Metals such as stainless steel may be used. The tip may be formed of composites, of alloys, and coatings and liners may be applied to the tip to increase performance or tool life.

The vacuum tip should provide sufficient vacuum to attach the die to the tip, while also providing mechanical support by contacting a majority of the surface area of the upper surface of the die, the tip contacting at least 80% of the upper surface. The cross sectional area of the vacuum tip should be similar to the area of the die, but may be less than that of the die, so long as the tip provides mechanical support to the die to prevent warping or deformation due to the use of the vacuum. The vacuum may be applied after the tip is aligned to and in contact with the upper surface of the die. This positioning is illustrated in FIG. 2. Prior to the contact of the bottom surface of the vacuum tip to the upper surface of the die, the vacuum is not supplied to the vacuum tip. After alignment and contact, the vacuum is applied to firmly attach the die to the vacuum tip, which can then move the die to another position for processing. Once the die is ready to be released from the tip, the vacuum is removed and the tip can be safely moved away from the die.

Exemplary processes where the embodiments are applicable include, but are not limited to, solder flux, die stacking, packaging, die sorting and other operations which require the die to be moved from one location to another in a pick and place operation. The vacuum tip may be used in a clean room or in a clean tool, in a manual tool, or as part of an automated process tool, or with a robot arm, for non limiting examples.

In an embodiment, an apparatus comprises a vacuum tip for attaching to an integrated circuit die comprising a vacuum port configured to connect to a vacuum supply on an upper surface and having a bottom surface; at least one vacuum hole extending through the vacuum tip and exposed at the bottom surface; wherein the vacuum tip is configured to physically contact a surface of an integrated circuit die.

In another embodiment, an apparatus for transporting an integrated circuit die comprises a vacuum tip having a vacuum port on an upper portion configured to connect to a vacuum supply; a plurality of vacuum holes coupled to the vacuum port extending through the vacuum tip and exposed at a bottom surface of the vacuum tip; the bottom surface of the vacuum tip configured to make physical contact to a surface of the integrated circuit die.

In another embodiment, a method for processing an integrated circuit die comprises providing a vacuum tip having a vacuum port on an upper portion configured to receive a vacuum supply, and having at least one vacuum hole extending through the vacuum tip, and having a planar bottom surface exposing the at least one vacuum hole; providing an integrated circuit die having a planar upper surface; positioning the vacuum tip in alignment with the integrated circuit die; placing the planar bottom surface of the vacuum tip in physical contact with the planar upper surface of the integrated circuit die; and applying a vacuum to attach the integrated circuit die to the vacuum tip.

Moreover, the scope of the present application is not intended to be limited to the particular embodiments of the structures, methods and steps described in the specification. As one of ordinary skill in the art will readily appreciate from the disclosure of the present invention, processes, or steps, presently existing or later to be developed, that perform substantially the same function or achieve substantially the same result as the corresponding embodiments described herein may be utilized according to the present invention. Accordingly, the appended claims are intended to include within their scope such processes or steps.

1. An apparatus, comprising:
an electrically non-conductive vacuum tip for attaching to an integrated circuit die comprising a vacuum port configured to connect to a vacuum supply on an upper surface and having a bottom surface; and
a vacuum hole coupled to the vacuum port and extending through the vacuum tip and exposed at the bottom surface of the vacuum tip;
wherein the bottom surface of the vacuum tip includes a pattern of vacuum paths extending radially outward from the vacuum hole and is configured to physically contact a surface of the integrated circuit die when the vacuum tip is lowered.

2. The apparatus of claim 1, wherein the vacuum tip comprises plastic.

3. The apparatus of claim 1, wherein the vacuum tip comprises ceramic.

4. The apparatus of claim 1, wherein the vacuum tip comprises Bakelite.

5. The apparatus of claim 1, wherein the vacuum tip comprises a thermoset resin.

6. The apparatus of claim 1, wherein the vacuum tip comprises glass.

7. The apparatus of claim 1, wherein the vacuum tip further comprises at least three vacuum holes arranged in a pattern.

8. The apparatus of claim 1, wherein the bottom surface of the vacuum tip is configured to make physical contact with at least 80 percent of the surface area of the surface of the integrated circuit die.

9. The apparatus of claim 1, wherein the bottom surface of the vacuum tip is configured to make physical contact with at least 90 percent of the surface area of the surface of the integrated circuit die.

10. An apparatus for transporting an integrated circuit die, comprising:
an electrically non-conductive vacuum tip having a vacuum port on an upper portion configured to connect to a vacuum supply; and
a vacuum hole coupled to the vacuum port extending through the vacuum tip and exposed at a bottom surface of the vacuum tip;
wherein the bottom surface of the vacuum tip includes a pattern of vacuum paths extending radially outward from the vacuum hole and is configured to make physical contact to a surface of the integrated circuit die when the vacuum tip is lowered.

11. The apparatus of claim 10, wherein the vacuum tip comprises plastic.

12. The apparatus of claim 10, wherein the vacuum tip comprises ceramic.

13. The apparatus of claim 10 wherein the vacuum tip comprises glass.

14. The apparatus of claim 10 wherein the vacuum tip comprises a thermoset resin.

15. The apparatus of claim 10 wherein the vacuum tip comprises Bakelite.

16. A method for processing an integrated circuit die, comprising:
providing a vacuum tip having a vacuum port on an upper portion configured to receive a vacuum supply, and having at least one vacuum hole extending through the vacuum tip and coupled to the vacuum port, and having a planar bottom surface exposing the at least one vacuum hole;
providing an integrated circuit die having a surface;
positioning the vacuum tip in alignment with the integrated circuit die;
placing the planar bottom surface of the vacuum tip in physical contact with a surface of the integrated circuit die; and
applying a vacuum to the vacuum port to attach the integrated circuit die to the vacuum tip.

17. The method of claim 16, wherein providing an integrated circuit die further comprises providing an integrated circuit die with solder bumps formed on another surface opposite the surface.

18. The method of claim 17, and further comprising:
transporting the integrated circuit die and the vacuum tip to a flux reservoir; and
using the vacuum tip to mechanically position the integrated circuit die, applying flux to the solder bumps.

19. The method of claim 16, wherein the vacuum tip bottom surface contacts at least 80 percent of the surface area of the surface of the integrated circuit die.

20. The method of claim 16, wherein the vacuum tip bottom surface contacts at least 90 percent of the surface area of the surface of the integrated circuit die.

21. The method of claim 16, wherein the integrated circuit die thickness is less than 10 mils.

22. The method of claim 21, wherein the integrated circuit die thickness is less than 5 mils.
